(19) United States
(12) Patent Application Publication
(10) Pub. No.: US 2018/0194100 A1
(43) Pub. Date: Jul. 12, 2018

(54) Hurricane/flood protection coverings

(71) Applicant: Laura Elvia McGrew, Raleigh, NC (US)

(72) Inventor: Laura Elvia McGrew, Raleigh, NC (US)

(21) Appl. No.: 15/732,870

(22) Filed: Jan. 8, 2018

Related U.S. Application Data
(63) Continuation of application No. 62/498,768, filed on Jan. 9, 2017.

(51) Int. Cl. B32B 5/02

(52) U.S. Cl. CPC B32B 5/02; B32B 2571/00; B32B 2307/5825; B32B 2307/546; B32B 2307/7265; B32B 2307/7244

(57) ABSTRACT

My Hurricane/Flood Protection Coverings Invention will be made with plastic and/or other reliable material/fabric and protection padding (as needed) that will secure and protect whatever it covers with an airtight seal to keep water and/or debris out. It will become the most needed and wanted protection for the intended uses mentioned above that will be superior to any like existing products. Also, I believe there is a very large market for this invention and can be produced and sold at a profit.

### CROSS REFERENCE TO RELATED APPLICATIONS

This Nonprovisional Utility Patent Application is in reference to my previous Provisional Patent Application for Hurricane/Flood Protection Coverings, Provisional Application No. 62/498768, Filing date Jan. 4, 2017.

### BACKGROUND OF INVENTION

### Background Information

1. My Hurricane/Flood Protection Coverings will be made with plastic and/or other reliable material/fabric and protection padding (as needed) that will secure and protect whatever it covers with an airtight seal to keep water and/or debris out.

2. My Hurricane/Flood Protection Coverings will become the most needed and wanted protection for the intended uses mentioned below.

3. I believe it will provide a unique solution to a real problem, and will be superior to any like existing products.

4. Also, I believe there is a very large market for this invention and can be produced and sold at a profit.

### SUMMARY OF THE INVENTION

1. Examples of extended use of my Hurricane/flood protection coverings are to cover and protect the following (a) personal items (e.g., clothes, pictures, and things of that sort); (b) home furnishings (e.g., furniture, sofas, entertaining centers, TVs, lamps, free standing appliances, washer & dryers, tables, chairs, beds, mattresses, bedding, and things of that sort); (c) technology (e.g., computes, printers, faxes, phones, shredders, tablets and things of that sort); (d) automobiles (e.g., cars, trucks, buses, and things of that sort); (e) aircrafts; (f) federal, state and local governments and business (e.g., furniture, equipment, free standing appliances & equipment, heating and cooling systems and things of that sort); and/or (g) anything that can be covered and protected before, during and after a hurricane/flood.

### Detailed Description of the Invention

1. My Hurricane/Flood Protection Coverings will be of quality material fabric will be waterproof, hopefully lightweight, water resistance, tear resistant, flexible to items covering and locks out water

1. What I claim as my invention are Hurricane/Flood Protection Coverings that will protect whatever it covers with an airtight seal to keep water and/or debris out.
